(19) United States
(12) Patent Application Publication
(10) Pub. No.: US 2026/0223180 A1
(43) Pub. Date: Jul. 30, 2026

(54) PRACH SEQUENCE SET ALLOCATION FOR COVERAGE ENHANCEMENT

(71) Applicant: QUALCOMM Incorporated, San Diego, CA (US)

(72) Inventors: Raviteja PATCHAVA, San Diego, CA (US); Jing SUN, San Diego, CA (US); Jing JIANG, San Diego, CA (US); Preeti KUMARI, San Diego, CA (US); Xiaoxia ZHANG, San Diego, CA (US); Junyi LI, Greentown, PA (US)

(21) Appl. No.: 19/041,602

(22) Filed: Jan. 30, 2025

(51) Int. Cl. H04W 74/0833; H04L 27/26

(52) U.S. Cl. CPC H04W 74/0833; H04L 27/2614

(57) ABSTRACT

The apparatus may be a wireless device configured to receive, from a network device, an indication of a plurality of preamble sequence sets for a random access procedure associated with the network device, where each preamble sequence set in the plurality of preamble sequence sets is associated with a different peak to average power ratio (PAPR) and transmit, based on one or more criteria for selecting a preamble sequence set, a random access message comprising a preamble sequence from a selected preamble sequence set of the plurality of preamble sequence sets. The apparatus may be a network device such as a base station configured to transmit, an indication of the plurality of preamble sequence sets and receive a random access message comprising a preamble sequence from a selected preamble sequence set of the plurality of preamble sequence sets.

### TECHNICAL FIELD

The present disclosure relates generally to communication systems, and more particularly, to a random access procedure.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device such as a user equipment (UE) configured to receive, from a network device, an indication of a plurality of preamble sequence sets for a random access procedure associated with the network device, where each preamble sequence set in the plurality of preamble sequence sets is associated with a different peak to average power ratio (PAPR) and transmit, based on one or more criteria for selecting a preamble sequence set, a random access message comprising a preamble sequence from a selected preamble sequence set of the plurality of preamble sequence sets.

In an aspect of the disclosure, a method, a computer-readable medium, and an apparatus are provided. The apparatus may be a network device such as a base station configured to transmit, an indication of a plurality of preamble sequence sets for a random access procedure associated with the network device, where each preamble sequence set in the plurality of preamble sequence sets is associated with a different PAPR and receive a random access message comprising a preamble sequence from a selected preamble sequence set of the plurality of preamble sequence sets.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 illustrates example aspects of a random access procedure between a UE and a base station.

FIG. 5A is a diagram illustrating different PAPR values associated with different preamble sequences as a function of a logical root index used to generate the preamble sequences.

FIG. 5B is a diagram illustrating a preamble sequence set partitioned into a plurality of preamble sequence (or logical root sequence) subsets in accordance with some aspects of the disclosure.

FIG. 6 is a call flow diagram illustrating a method of wireless communication in accordance with some aspects of the disclosure.

FIG. 7 is a flowchart of a method of wireless communication.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a diagram illustrating an example of a hardware implementation for an apparatus.

FIG. 13 is a diagram illustrating an example of a hardware implementation for a network entity.

### DETAILED DESCRIPTION

In some aspects of wireless communication, a random access, or initial access, procedure may involve a first random access message (e.g., a msg1) transmission in a physical random access channel (PRACH). Before transmitting a first random access message (e.g., a msg1), a UE may randomly pick a preamble from a set of preambles, or preamble sequences, allocated, or indicated, by a base station. In some aspects, the base station may select and/or allocate the preambles from a set of a Zadoff-Chu (ZC) sequences. For a first random access message, a UE may compute a transmit power based on open loop power control using a DL reference power received power (RSRP). If there is no random access response (RAR) (e.g., a msg2) from a base station in response to the transmitted first random access message (e.g., the msg1), the UE may apply a power ramp (an increased power) for a transmission of the first random access message in the next PRACH interval. In some aspects, a UE may continue to apply a power ramp until it receives the RAR from the base station, or until it reaches a maximum transmission power.

For a particular UE, a coverage area (or cell edge) for PRACH, in some aspects, may be associated with a maximum transmission power of the UE (or the first random access message). For example, the coverage area (or cell edge) may be based on whether the base station is capable of detecting a first random access message (or msg1) transmitted with a maximum transmit power from the UE. However, for a given ZC sequence length, different ZC sequences are associated with, or have, different PAPR values. The different PAPR values, in some aspects, may be associated with different characteristics of a power amplification/power amplifier (PA). For example, a PA for a ZC sequence having a lower PAPR may be associated with a lower backoff value (a reduction in the magnitude of an amplification to avoid signal distortion based on a non-linear region of a PA curve relating input power to the PA and an output power from the PA). The lower backoff value may correspond to a higher maximum transmit power (and larger coverage area/greater coverage) for a first ZC sequence with a lower PAPR than a second ZC sequence.

Various aspects relate generally to grouping PRACH sequences based on their PAPR characteristics so that a UE is able to transmit PRACH at a higher power if the UE is at the cell edge by switching between different PRACH sequence sets. Some aspects more specifically relate to multiple sequence set allocations based on PAPR for first random access message preambles to improve PRACH coverage. In some examples, a wireless device, such as a UE, may be configured to receive, from a network device, an indication of a plurality of preamble sequence sets for a random access procedure associated with the network device, where each preamble sequence set in the plurality of preamble sequence sets is associated with a different PAPR and transmit, based on one or more criteria for selecting a preamble sequence set, a random access message comprising a preamble sequence from a selected preamble sequence set of the plurality of preamble sequence sets. In some aspects, a base station may be configured to transmit, an indication of a plurality of preamble sequence sets for a random access procedure associated with the network device, where each preamble sequence set in the plurality of preamble sequence sets is associated with a different PAPR and receive a random access message comprising a preamble sequence from a selected preamble sequence set of the plurality of preamble sequence sets.

Particular aspects of the subject matter described in this disclosure can be implemented to realize one or more of the following potential advantages. In some examples, by providing multiple sequence set allocations for first random access message preambles based on a PAPR of the sequences, the described techniques can be used to improve PRACH coverage.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

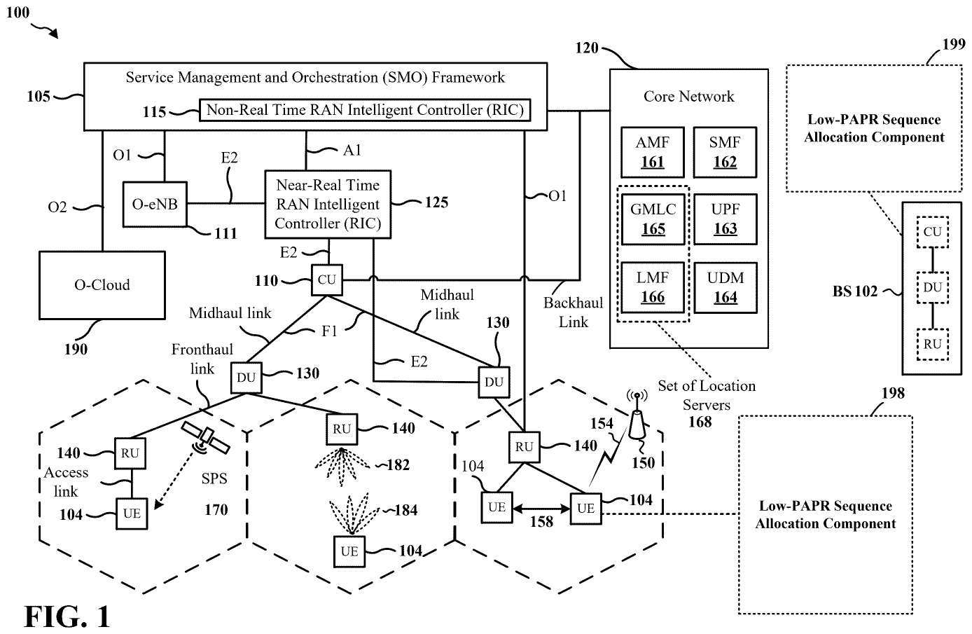

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a low PAPR sequence allocation component 198 that may be configured to receive, from a network device, an indication of a plurality of preamble sequence sets for a random access procedure associated with the network device, where each preamble sequence set in the plurality of preamble sequence sets is associated with a different PAPR and transmit, based on one or more criteria for selecting a preamble sequence set, a random access message comprising a preamble sequence from a selected preamble sequence set of the plurality of preamble sequence sets. In certain aspects, the base station 102 may have a low PAPR sequence allocation component 199 that may be configured to transmit, an indication of a plurality of preamble sequence sets for a random access procedure associated with the network device, where each preamble sequence set in the plurality of preamble sequence sets is associated with a different PAPR and receive a random access message comprising a preamble sequence from a selected preamble sequence set of the plurality of preamble sequence sets. Although the following description may be focused on 5G NR, the concepts described herein may be applicable to other similar areas, such as LTE, LTE-A, CDMA, GSM, and other wireless technologies.

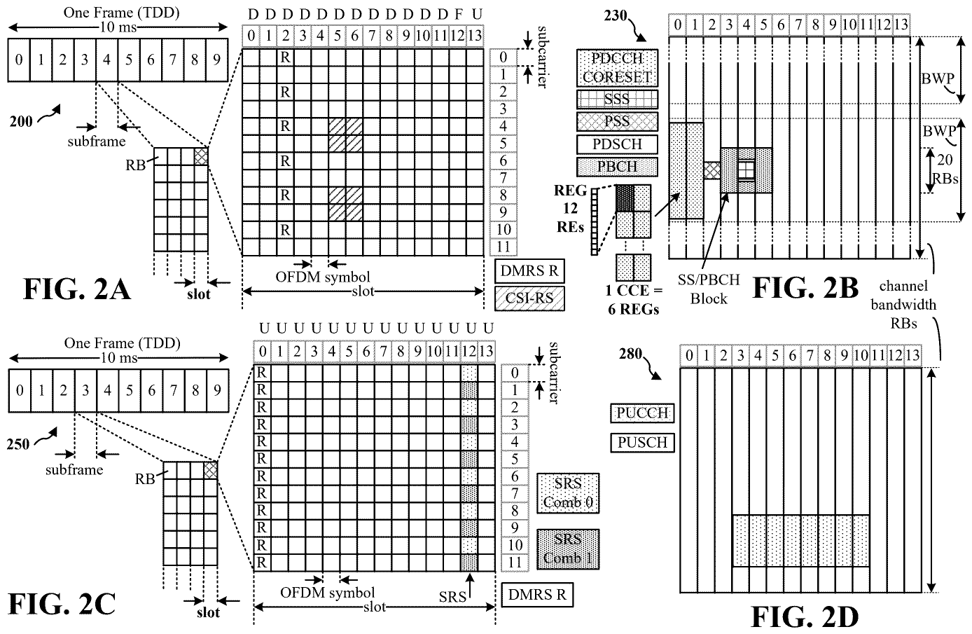

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

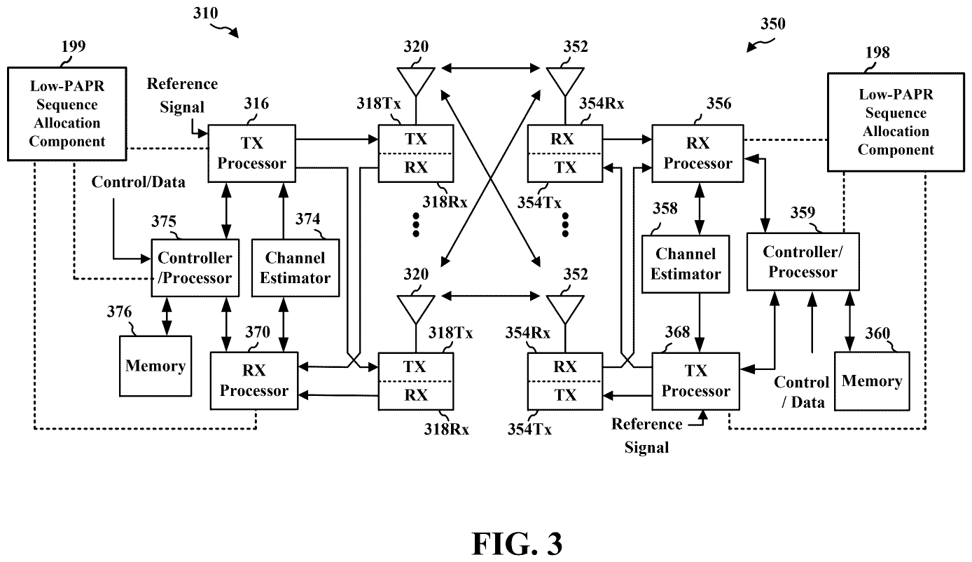

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the low PAPR sequence allocation component 198 of FIG. 1.

At least one of the TX processor 316, the RX processor 370, and the controller/processor 375 may be configured to perform aspects in connection with the low PAPR sequence allocation component 199 of FIG. 1.

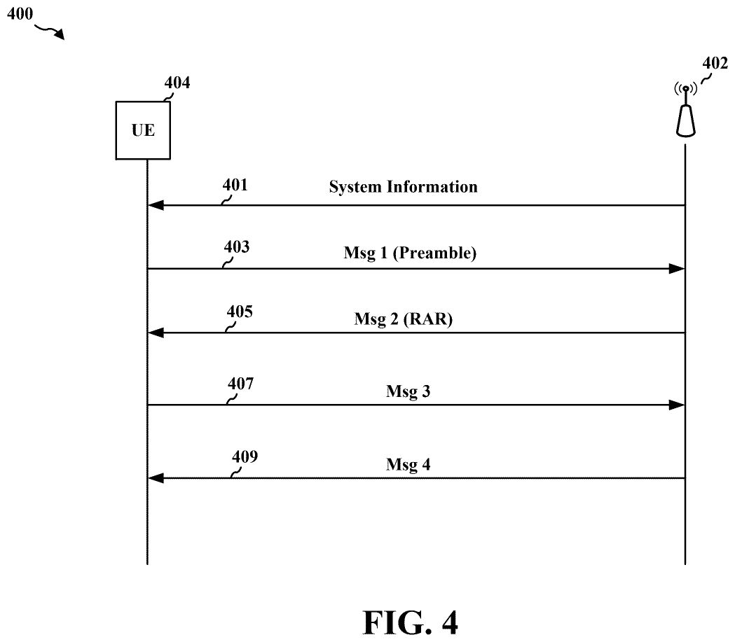

FIG. 4 illustrates example aspects of a random access procedure 400 between a UE 404 and a base station 402. The UE 404 may initiate the random access message exchange by sending, to the base station 402, a first random access message 403 (e.g., Msg 1 or msg1) including a preamble in a RO. Prior to sending the first random access message 403, the UE may obtain, e.g., in system information 401 from the base station 402, random access parameters. The random access parameters, in some aspects, may include preamble format parameters, time and frequency resources, parameters for determining root sequences and/or cyclic shifts for a random access preamble, etc. The preamble may be transmitted with an identifier, such as a Random Access radio network temporary identifier (RNTI), or RA-RNTI. The UE 404 may randomly select a random access preamble sequence, e.g., from a set of preamble sequences. If the UE 404 randomly selects the preamble sequence, the base station 402 may receive another preamble from a different UE at the same time. In some examples, a preamble sequence may be assigned to the UE 404.

The base station responds to the first random access message 403 by sending a second random access message 405 (e.g., Msg 2 or msg2) using PDSCH and including a RAR. The RAR may include, e.g., an identifier of the random access preamble sent by the UE, a time advance (TA), an uplink grant for the UE to transmit data, cell radio network temporary identifier (C-RNTI) or other identifier, and/or a back-off indicator. Upon receiving the RAR (in the second random access message 405), the UE 404 may, based on the uplink grant included in the second random access message 405, transmit a third random access message 407 (e.g., Msg 3 or msg3) to the base station 402, e.g., using PUSCH, that may include a RRC connection request, an RRC connection re-establishment request, or an RRC connection resume request, depending on the trigger for the initiating the random access procedure. The base station 402 may then complete the random access procedure by sending a fourth random access message 409 (e.g., Msg 4 or msg4) to the UE 404, e.g., using PDCCH for scheduling and PDSCH for the message. The fourth random access message 409 may include a random access response message that includes timing advance information, contention resolution information, and/or RRC connection setup information. The UE 404 may monitor for PDCCH, e.g., with the C-RNTI. If the PDCCH is successfully decoded (or detected), the UE 404 may also decode PDSCH. The UE 404 may send HARQ feedback for any data carried in the fourth random access message. If two UEs sent a same preamble in the first random access message 403, both UEs may receive the RAR leading both UEs to send a third random access message 407. The base station 402 may resolve such a collision by being able to decode the third random access message from one of the UEs and responding with a fourth random access message to that UE. The other UE, which did not receive the fourth random access message 409, may determine that random access did not succeed and may re-attempt random access. Thus, the fourth message may be referred to as a contention resolution message. The fourth random access message 409 may complete the random access procedure. Thus, the UE 404 may then transmit uplink communication and/or receive downlink communication with the base station 402 based on the fourth random access message 409.

In order to reduce latency or control signaling overhead, a single round trip cycle between the UE and the base station may be achieved in a 2-step RACH process. Aspects of Msg 1 and Msg 3 may be combined in a single message, e.g., which may be referred to as Msg A. The Msg A may include a random access preamble, and may also include a PUSCH transmission, e.g., such as data. The MsgA preambles may be separate from the four step preambles, yet may be transmitted in the same ROs as the preambles of the four step RACH procedure or may be transmitted in separate ROs. The PUSCH transmissions may be transmitted in PUSCH occasions (POs) that may span multiple symbols and PRBs. After the UE transmits the Msg A, the UE may wait for a response from the base station. Additionally, aspects of the Msg 2 and Msg 4 may be combined into a single message, which may be referred to as Msg B.

In some aspects of wireless communication, a random access, or initial access, procedure may involve a first random access message (e.g., a msg1) transmission in a PRACH. Before transmitting a first random access message (e.g., a msg1), a UE may randomly pick a preamble from a set of preambles, or preamble sequences, allocated, or indicated, by a base station. In some aspects, the base station may select and/or allocate the preambles from a set of a Zadoff-Chu (ZC) sequences. For a first random access message, a UE may compute a transmit power based on open loop power control using a DL reference power received power (RSRP). If there is no random access response (RAR) (e.g., a msg2) from a base station to the transmitted first random access message (e.g., the msg1), the UE may apply a power ramp (an increased power) for a transmission of the first random access message in the next PRACH interval. In some aspects, a UE may continue to apply a power ramp until it receives the RAR from the base station, or until it reaches a maximum transmission power.

For a particular UE, a coverage area (or cell edge) for PRACH, in some aspects, may be associated with a maximum transmission power of the UE (or the first random access message). For example, the coverage area (or cell edge) may be based on whether the base station is capable of detecting a first random access message (or msg1) transmitted with a maximum transmit power from the UE. However, for a given ZC sequence length, different ZC sequences are associated with, or have, different PAPR values. The different PAPR values, in some aspects, may be associated with different characteristics of a power amplification/power amplifier (PA). For example, a PA for a ZC sequence having a lower PAPR may be associated with a lower backoff value (a reduction in the magnitude of an amplification to avoid signal distortion based on a non-linear region of a PA curve relating input power to the PA and an output power from the PA). The lower backoff value may correspond to a higher maximum transmit power (and larger coverage area/greater coverage) for a first ZC sequence with a lower PAPR than a second ZC sequence.

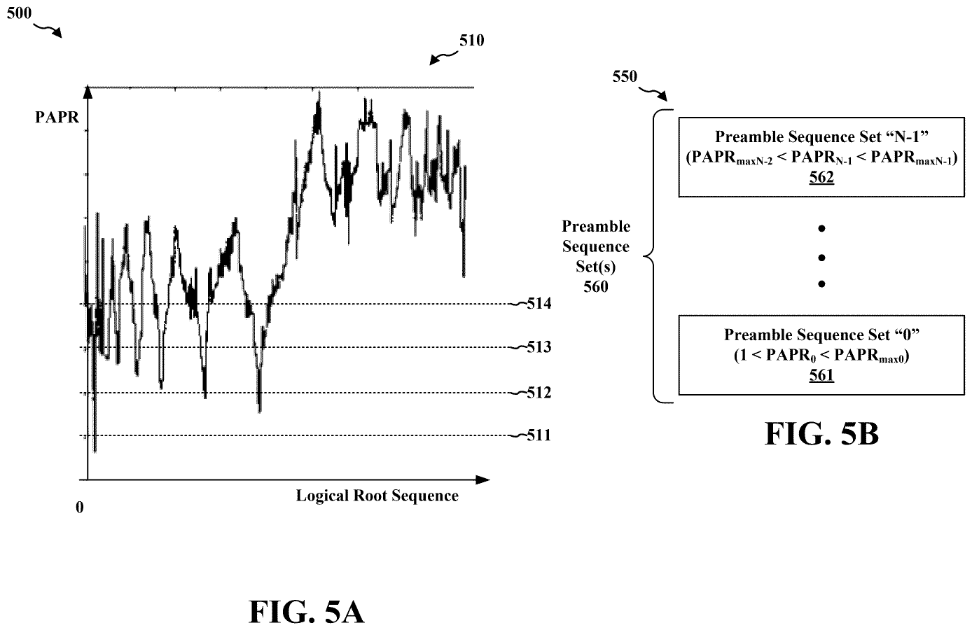

FIG. 5A is a diagram 500 illustrating different PAPR values associated with different preamble sequences as a function of a logical root index used to generate the preamble sequences. A preamble sequence, or ZC sequence, may be generated based on a length of the sequence (L_{RA}), a root (or logical root) (u) and a cyclic shift value (C). A sequence of values based on a particular root or logical root associated with a logical root index may be referred to as a root sequence or logical root sequence. A particular preamble sequence, may be identified by a root sequence and a cyclic shift indicating a position in the root sequence at which the preamble sequence begins, for example. As the preamble sequence has the same length as the root sequence, when the preamble reaches a last value in the root sequence, the preamble sequence continues at the beginning of the root sequence.

As the values in a particular root sequence are fixed, preamble sequences using the same root sequence share/have a same PAPR. A graph 510 illustrates a relationship between PAPR and a logical root sequence (which may be associated with, or referred to as, a root sequence, a root sequence index, a logical sequence index, or a logical root sequence index) for a sequence length of 839. For illustrative purposes, a set of PAPR thresholds (e.g., a first threshold 511, a second threshold 512, a third threshold 513, and a fourth threshold 514) that may be used to partition the set of logical root sequences into one or more partitions, or subsets, of logical root sequences associated with different ranges of PAPR values (or maximum PAPR values).

FIG. 5B is a diagram 550 illustrating a preamble sequence set 560 partitioned into a plurality of preamble sequence (or logical root sequence) subsets in accordance with some aspects of the disclosure. Diagram 550 illustrates a preamble sequence set 560 from which a preamble sequence for an initial random access message may be selected. The preamble sequence set 560, in some aspects, may be divided in to a plurality of subsets (e.g., a total of N≥2 subsets). For example, the preamble sequence set 560 may include at least a first preamble sequence subset (e.g., preamble sequence set “0” 561) associated with root sequences having, or associated with, a PAPR that is within a first range (e.g., from 1 to PAPRₘₐₓ₀) and an N^{th} preamble sequence subset (e.g., preamble sequence set “N−1” 562) associated with root sequences having, or associated with, a PAPR that is within an N^{th} range (e.g., from PAPR_{maxN-2} to PAPR_{maxN-1}, where the upper limit may not be used). For example, referring to FIG. 5A, subsets may be grouped based on the first threshold 511, the second threshold 512, the third threshold 513, and the fourth threshold 514, where a first subset may include preamble sequences, or preamble sequence roots, having a PAPR below, or less than, the first threshold 511 and an N^{th} preamble sequence subset that includes preamble sequences, or preamble sequence roots, having a PAPR above, or greater than, the fourth threshold 514. In some aspects, the preamble sequence set 560 may include two subsets based a single threshold (e.g., a maximum (or minimum) value for being classified/identified as having a low (or high) PAPR, or being a low (or high) PAPR preamble sequence), such that preamble sequences (or root sequences) having a PAPR below, or less than, the single threshold value (e.g., any of first threshold 511, the second threshold 512, the third threshold 513, and the fourth threshold 514) belong to a first (low PAPR) subset (or low PAPR preamble sequence set) and such that preamble sequences (or root sequences) having a PAPR above, or greater than, the single threshold value belong to a second (high, or not-low, PAPR) subset (or high, or not-low, PAPR preamble sequence set). In some aspects, separate reference tables (e.g., tables used in conjunction with a starting root to determine a preamble sequence set, such as a set of candidate preamble sequences, by a base station and a UE) may be generated for low PAPR sequence roots (e.g., for logical roots, logical sequence roots, logical root indexes, or logical sequence root indexes meeting a low PAPR criteria) and for high PAPR sequence roots (e.g., for logical roots, logical sequence roots, logical root indexes, or logical sequence root indexes not meeting the low PAPR criteria). In some aspects, a plurality of low PAPR and high PAPR tables may be generated, grouped, configured, defined, and/or specified based on different threshold values for a characteristic of the root sequences (e.g., different maximum PAPR values associated with low PAPR root sequences). For example, a network node may select the PRACH sequence sets so that the sequences within one PRACH sequence set have a similar range of PAPR.

Various aspects relate generally to grouping PRACH sequences based on their PAPR characteristics so that a UE is able to transmit PRACH at a higher power if the UE is at the cell edge by switching between different PRACH sequence sets. Some aspects more specifically relate to multiple sequence set allocations based on PAPR for first random access message preambles to improve PRACH coverage. In some examples, a wireless device may be configured to receive, from a network device, an indication of a plurality of preamble sequence sets for a random access procedure associated with the network device, where each preamble sequence set in the plurality of preamble sequence sets is associated with a different PAPR and transmit, based on one or more criteria for selecting a preamble sequence set, a random access message comprising a preamble sequence from a selected preamble sequence set of the plurality of preamble sequence sets. In some aspects, a base station may be configured to transmit, an indication of a plurality of preamble sequence sets for a random access procedure associated with the network device, where each preamble sequence set in the plurality of preamble sequence sets is associated with a different PAPR and receive a random access message comprising a preamble sequence from a selected preamble sequence set of the plurality of preamble sequence sets.

Particular aspects of the subject matter described in this disclosure can be implemented to realize one or more of the following potential advantages. In some examples, by providing multiple sequence set allocations for first random access message preambles based on a PAPR of the sequences, the described techniques can be used to improve PRACH coverage.

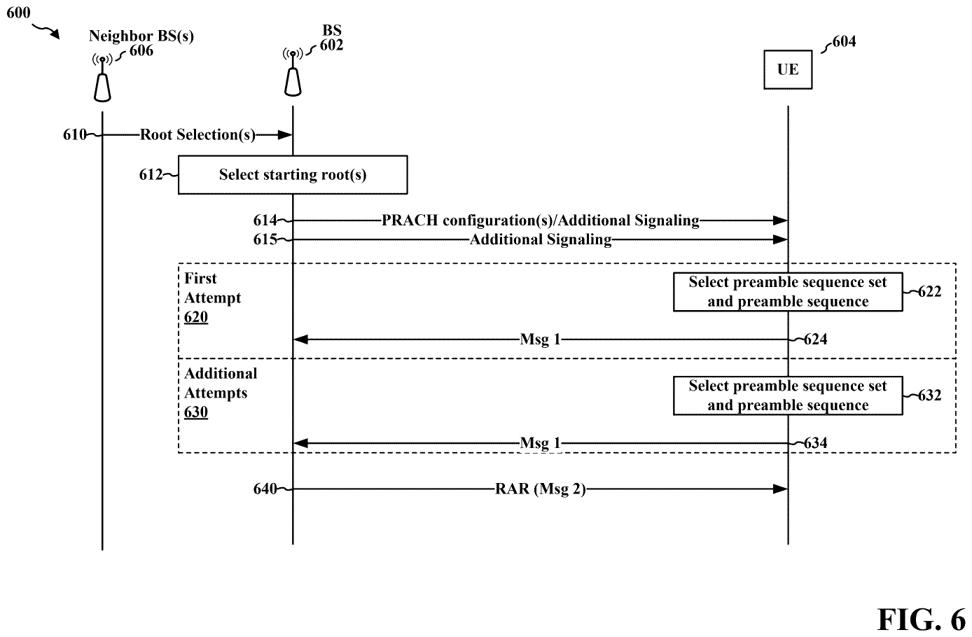

FIG. 6 is a call flow diagram 600 illustrating a method of wireless communication in accordance with some aspects of the disclosure. The method is illustrated in relation to a base station 602 (e.g., as an example of a network device or network node that may include one or more components of a disaggregated base station) in communication with a UE 604 (e.g., as an example of a wireless device) and in communication with at least one additional base station, e.g., base station(s) 606. The functions ascribed to the base station 602, in some aspects, may be performed by one or more components of a network entity, a network node, or a network device (a single network entity/node/device or a disaggregated network entity/node/device as described above in relation to FIG. 1). Similarly, the functions ascribed to the UE 604, in some aspects, may be performed by one or more components of a wireless device supporting communication with a network entity/node/device. Accordingly, references to “transmitting” in the description below may be understood to refer to a first component of the base station 602 (or the UE 604) outputting (or providing) an indication of the content of the transmission to be transmitted by a different component of the base station 602 (or the UE 604). Similarly, references to “receiving” in the description below may be understood to refer to a first component of the base station 602 (or the UE 604) receiving a transmitted signal and outputting (or providing) the received signal (or information based on the received signal) to a different component of the base station 602 (or the UE 604).

The base station 602, in some aspects, may receive from the base station(s) 606 one or more root selection(s) 610 indicating starting roots selected by the base station(s) 606. In some aspects, the one or more root selection(s) 610 may include a plurality of indications of starting roots from a plurality of neighboring network devices (e.g., the base station(s) 606). The one or more root selection(s) 610, in some aspects, may include a plurality of indications of starting roots from a single neighboring network device. For example, a single neighboring device may indicate a starting root associated with a first subset of preamble sequence sets having, or associated with, a first PAPR that is less than a first threshold (e.g., a PAPR threshold or low-PAPR threshold) and an additional starting root associated with a second subset of preamble sequence sets having, or associated with, a second PAPR that is greater than the first threshold that have been selected by the neighboring network device for a random access procedure (e.g., to be indicated in a PRACH configuration for UEs attempting to perform a random access procedure with the neighboring network device).

Based on the one or more root selection(s) 610, the base station 602 may determine, as part of selecting one or more starting roots at 612, a set of roots or root indexes to exclude when selecting a starting root for a local random access procedure (e.g., the indicated starting roots, or root indexes, and associated/adjacent roots and/or root indexes). The base station 606, in some aspects, may, as part of selecting one or more starting roots at 612, determine a (common) starting root (e.g., a common root index that will be used to define both a set of normal/high PAPR preamble sequences, or sequence roots, and a set of low PAPR preamble sequences, or sequence roots). The common starting root, for example, may be an index into a table (or other indexed data structure) of root sequences (or root sequence identifiers). In some aspects, a set of candidate sequences (e.g., a preamble sequence set 560 of FIG. 5B) may be determined based on the common starting root, a cyclic shift spacing (N_{CS}) (or different cyclic shift spacings for different subsets of sequence roots, where low PAPR sequence roots may be associated with larger cyclic shift spacings than normal/high PAPR sequence roots), and a total number of candidate preamble sequences to generate/define. For example, the selection, in some aspects, may include selecting a starting root and then identifying in increasing order of a first increasing cyclic shift Cv of a logical root sequence (where v is an index into a set of cyclic shift values based on a cyclic shift spacing associated with the logical root sequence), and then in increasing order of the logical root sequence index (e.g., a defined table in a standard). In some aspects, a cyclic shift spacing associated with different logical root sequences may be different, e.g., low PAPR logical root sequences may be associated with a larger cyclic shift spacing than normal/high PAPR logical root sequences.

The base station 606, in some aspects, may, as part of selecting one or more starting roots at 612, determine a first starting root for a low PAPR set of sequence roots and/or preamble sequences and determine a second starting root for a normal/high PAPR set of sequence roots and/or preamble sequences. While described for two subsets (e.g., a low PAPR subset and a normal/high PAPR subset), in some aspects, additional subsets may be defined as described in relation to FIG. 5B, and a starting root may be selected for each subset. For example, the base station 602 may select the first starting root from a first set of starting roots associated with the first subset of preamble sequence sets (e.g., low PAPR sequence roots not excluded based on the one or more root selection(s) 610). Similarly, the base station 602 may select the second starting root from a second set of starting roots associated with the second subset of preamble sequence sets (e.g., normal/high PAPR sequence roots not excluded based on the one or more root selection(s) 610). In some aspects, each subset of preamble sequences may be associated with a corresponding (PRACH) configuration (e.g., the starting root, a cyclic shift spacing (N_{CS}), a total number of candidate preamble sequences to generate/define, etc.). In some aspects, the candidate preamble sequences allocated to, or generated for, the low PAPR subset (e.g., based on a common starting root or a separate starting root) may be determined based on traffic considerations. For example, during heavy traffic, a smaller percentage of a total number of candidate preamble sequences may be allocated for use as a low PAPR subset of preamble sequences.

Based on the selection at 612, the base station 602 may transmit, and the UE 604 may receive, one or more PRACH configurations 614, and in some aspects, additional related signaling 615. For example, when a common starting root is selected at 612, the one or more PRACH configurations 614 and additional related signaling 615 may include an indication of, or be associated with, a total number of sequences in a set of candidate preamble sequences, the subset of low (or normal/high) PAPR candidate preamble sequences (e.g., through a set of root, or sequence root, values or indexes), a cyclic shift spacing associated with the low PAPR roots/sequence roots (where, the N_{CS} value for the low (or lower) PAPR sequences, or preamble sequence, may be different from, or larger/higher than, the regular (normal/high PAPR) sequences, based on, for example, the users at a cell edge likely to use the low PAPR sequences having a higher/longer round trip time (RTT)). In some aspects, the one or more PRACH configurations 614 and additional related signaling 615 may include, or be transmitted via, either SIB or RRC signaling. In some aspects, the low PAPR subset may be implicitly defined based on known or pre-configured information (e.g., tables) and the one or more PRACH configurations 614 and additional related signaling 615 may indicate to the UE the number of sequences associated with a low PAPR transmission. When separate starting roots are selected at 612, the one or more PRACH configurations 614 and additional related signaling 615 may include separate PRACH configurations for each subset of candidate preamble sequences, where one or more of the number of sequences and a cyclic shift spacing associated with each subset may be separately indicated (e.g., to be, or take, a same value or different values).

In some aspects, the different subsets may be associated with different characteristics of the communication environment. For example, when using two subsets, a first subset may be associated with one or more of a measured RSRP at a device, a target UL power (e.g., an expected received power of an UL transmission at a particular power that may be based on the RSRP), a number of previous and/or failed attempts (e.g., random access message transmissions for which no response was received), the use of a maximum transmission power for a random access message (e.g., the low PAPR subset may be associated with random access message transmitted using a maximum transmission power independent of the RSRP/target UL power), or a capability and/or an operational mode of a UE (e.g., a low power mode associated with reducing failed attempts, and boosting a target UL power by using a preamble sequence from the low PAPR sequence subset and reducing a power backoff associated with a PA at the UE). The one or more PRACH configurations 614 and additional related signaling 615, in some aspects, may indicate these associations between the different subsets and the different characteristics and/or criteria for selecting a preamble sequence subset (e.g., a preamble sequence from a particular preamble sequence subset).

In association with a first random access attempt 620, the UE 604 may, at 622 select a preamble sequence set and a preamble sequence from the selected preamble sequence set. The selection at 622 may be based on the different preamble sequence subsets and the characteristics and/or criteria for selecting a preamble sequence subset indicated in the one or more PRACH configurations 614 and additional related signaling 615 (and discussed above). For example, the UE 604 may determine that no previous random access attempts were made, but that an RSRP or target UL power is below a threshold (or within a range of values) associated with selecting the (or a particular) low (or lower) PAPR sequence subset and (randomly) selecting a preamble sequence from the low (or lower) PAPR sequence subset.

In some aspects, in association with the first random access attempt 620, the UE 604 may select, at 622, a normal/high PAPR sequence subset from which to select a preamble sequence based on an RSRP/target UL power being above the threshold value. The UE 604 may transmit a random access message 624 (e.g., Msg 1). In some aspects, when transmitting the random access message 624, the UE may use a power (or PA) backoff based on the PAPR of the selected preamble sequence or a PAPR associated with the selected subset of the preamble sequences (e.g., a smaller power/PA backoff based on a first PAPR associated with a low PAPR subset, or a larger power/PA backoff based on a second PAPR associated with a normal/high PAPR subset).

If the base station 602 fails to receive the random access message 624, or the UE 604 fails to receive a RAR in response to the random access message 624, the UE may make additional random access attempts 630. For each random access attempt of the additional random access attempts 630, the UE 604 may, at 632 select a preamble sequence set and a preamble sequence from the selected preamble sequence set and transmit a random access message 634. The selection at 632 may be based on the different preamble sequence subsets and the characteristics and/or criteria for selecting a preamble sequence subset indicated in the one or more PRACH configurations 614 and additional related signaling 615 (and discussed above). Additionally, each selection at 632, may be based on different conditions at the UE 604 that may lead to the selection of a different subset of the preamble sequence set. For example, for a first additional attempt, a normal/high PAPR subset may be selected based on a first number of failed random access attempts that is below, or lower than, a threshold number of failed attempts associated with the low PAPR subset, while, for a subsequent additional attempt, a low PAPR subset may be selected based on a second number of failed random access attempts that is above, or greater than, the threshold number associated with the low PAPR subset. Similarly, a switch from selecting a low PAPR subset to selecting a normal/high PAPR subset in a subsequent random access attempt of the additional random access attempts 630 may be based on moving closer to the base station 602 and measuring an increased RSRP and/or calculating an increased target UL power that crosses an associated threshold.

In some aspects, the base station 602 may receive the random access message 624, and in response to the random access message 624, the base station 602 may transmit, and the UE 604 may receive a RAR 640 (e.g., Msg 2). In such a case, the additional random access attempts 630 may include zero additional random access attempts 630. The random access procedure, in some aspects may continue with one or more random additional messages

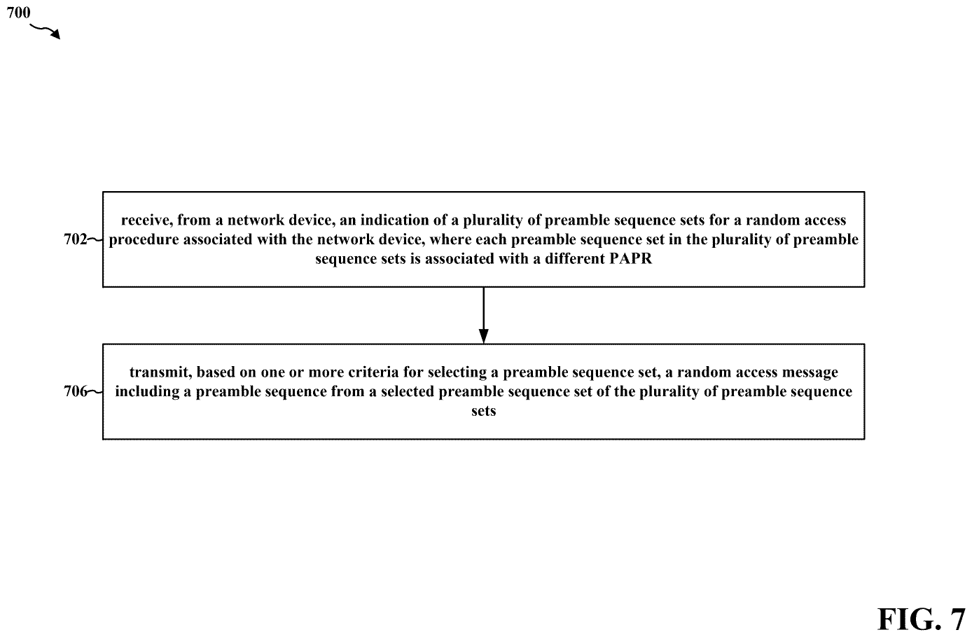

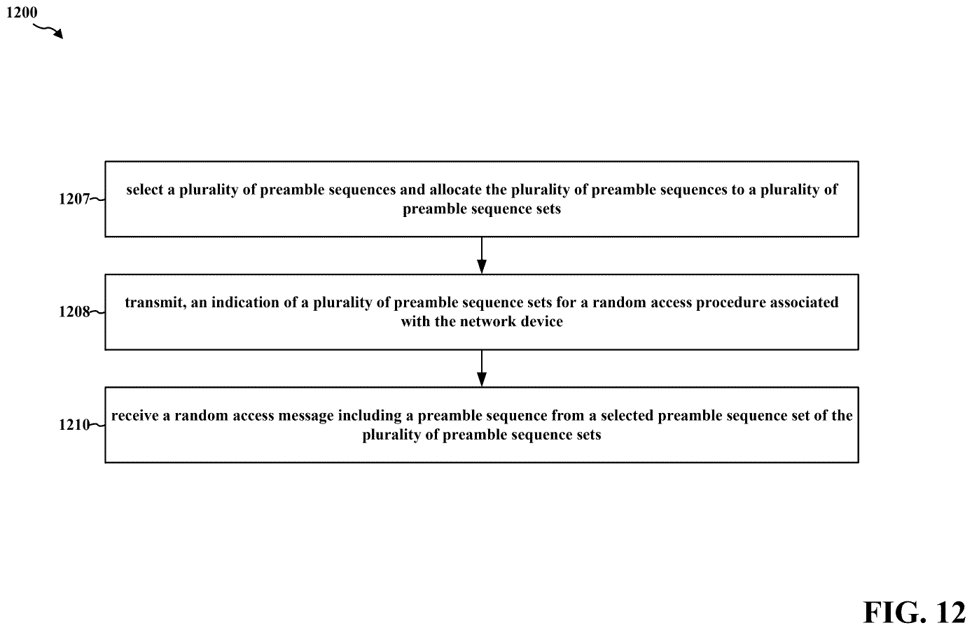

FIG. 7 is a flowchart 700 of a method of wireless communication. The method may be performed by a UE (e.g., the UE 104, 604; the apparatus 1204). At 702, the UE may receive, from a network device, an indication of a plurality of preamble sequence sets for a random access procedure associated with the network device. In some aspects, each preamble sequence set in the plurality of preamble sequence sets is associated with a different PAPR. For example, 702 may be performed by application processor(s) 1206, cellular baseband processor(s) 1224, transceiver(s) 1222, antenna(s) 1280, and/or low PAPR sequence allocation component 198 of FIG. 12. In some aspects, the plurality of preamble sequence sets may include a first subset of preamble sequence sets associated with a first PAPR that is less than a first PAPR threshold and a second subset of preamble sequence sets associated with a second PAPR that is greater than the first PAPR threshold. The indication of the plurality of preamble sequence sets, in some aspects, may include one or more of: a common starting root associated with the plurality of preamble sequence sets, a first starting root associated with the first subset of preamble sequence sets, a second starting root associated with the second subset of preamble sequence sets, a first cyclic shift distance between adjacent preamble sequences in the first subset of preamble sequence sets, a second cyclic shift distance between adjacent preamble sequences in the second subset of preamble sequence sets, or one or more indications of one or more criteria for selecting the preamble sequence set.

In some aspects, the one or more criteria for selecting the preamble sequence set may include one or more of: a first set of power thresholds associated with a RSRP for a reference signal from the network device, a second set of power thresholds associated with a target UL power associated with the random access message, a transmission power associated with the random access message being a maximum transmission power for the random access message, or a third set of threshold numbers of failed random access messages. Each preamble sequence set in the plurality of preamble sequence sets, in some aspects, may be associated with one or more of a first range of powers associated with the RSRP for the reference signal from the network device, a second range of powers associated with the targeted UL power, the transmission power being the maximum transmission power, or a third range of numbers of the failed random access messages. In some aspects, the indication of the plurality of preamble sequence sets may include the common starting root associated with the plurality of preamble sequence sets, and the indication of the plurality of preamble sequence sets may further include one or more of: a set of root values associated with one of the first subset of preamble sequence sets or the second subset of preamble sequence sets, or a number of sequences in the first subset of preamble sequence sets. The first cyclic shift distance, in some aspects, may be greater than the second cyclic shift distance. In some aspects, each preamble sequence set of the plurality of preamble sequence sets may be further associated with a different range of PAPRs.

In some aspects, the indication of the plurality of preamble sequence sets indicates, for each preamble sequence set in the plurality of preamble sequence sets, one or more of: a number of sequences in the preamble sequence set, a cyclic shift distance between adjacent preamble sequences in the preamble sequence set, a threshold value associated with one of a reference signal received power (RSRP) for a reference signal from the network device or a targeted uplink (UL) power, or a threshold number of failed random access attempts. The threshold value associated with one of the RSRP or the targeted UL power, in some aspects, may be based on characteristics of a device receiving the indication. In some aspects, the characteristics may include at least one of a type of the device, a capability of the device, a state of the device, or a mode of operation of the device. For example, referring to FIG. 6, the UE 604 may receive, the one or more PRACH configurations 614, and in some aspects, additional related signaling 615.

At 706, the UE may transmit, based on one or more criteria for selecting a preamble sequence set, a random access message comprising a preamble sequence from a selected preamble sequence set of the plurality of preamble sequence sets. In some aspects, the UE may select, based on the one or more criteria for selecting the preamble sequence set, the preamble sequence set from the plurality of preamble sequence sets and the preamble sequence within the preamble sequence set for a random access message (Msg 1). For example, 706 may be performed by application processor(s) 1206, cellular baseband processor(s) 1224, transceiver(s) 1222, antenna(s) 1280, and/or low PAPR sequence allocation component 198 of FIG. 12. In some aspects, the preamble sequence may be a first preamble sequence from the first subset of preamble sequence sets and transmitting the random access message includes using a power amplification backoff value that is based on one of the first PAPR threshold or a PAPR associated with the preamble sequence. For example, referring to FIG. 6, UE 604 may, at 622/632, select a preamble sequence set and a preamble sequence from the selected preamble sequence set and based on the selection at 622/632, the UE 604 may transmit the random access message 624/634.

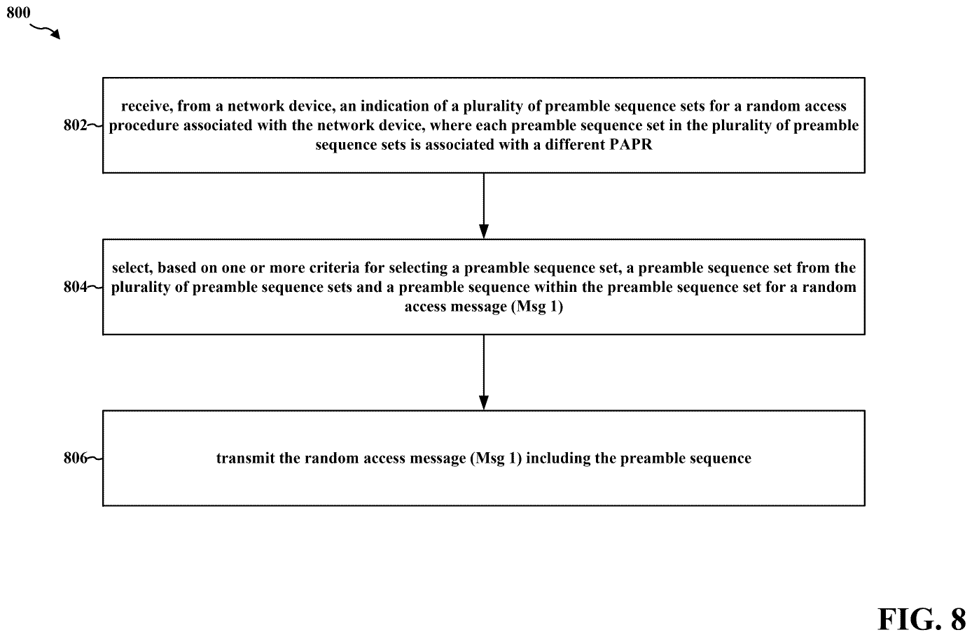

FIG. 8 is a flowchart 800 of a method of wireless communication. The method may be performed by a UE (e.g., the UE 104, 604; the apparatus 1204). At 802, the UE may receive, from a network device, an indication of a plurality of preamble sequence sets for a random access procedure associated with the network device. In some aspects, each preamble sequence set in the plurality of preamble sequence sets is associated with a different PAPR. For example, 802 may be performed by application processor(s) 1206, cellular baseband processor(s) 1224, transceiver(s) 1222, antenna(s) 1280, and/or low PAPR sequence allocation component 198 of FIG. 12. In some aspects, the plurality of preamble sequence sets may include a first subset of preamble sequence sets associated with a first PAPR that is less than a first PAPR threshold and a second subset of preamble sequence sets associated with a second PAPR that is greater than the first PAPR threshold. The indication of the plurality of preamble sequence sets, in some aspects, may include one or more of: a common starting root associated with the plurality of preamble sequence sets, a first starting root associated with the first subset of preamble sequence sets, a second starting root associated with the second subset of preamble sequence sets, a first cyclic shift distance between adjacent preamble sequences in the first subset of preamble sequence sets, a second cyclic shift distance between adjacent preamble sequences in the second subset of preamble sequence sets, or one or more indications of one or more criteria for selecting the preamble sequence set.

In some aspects, the one or more criteria for selecting the preamble sequence set may include one or more of: a first set of power thresholds associated with a RSRP for a reference signal from the network device, a second set of power thresholds associated with a target UL power associated with the random access message, a transmission power associated with the random access message being a maximum transmission power for the random access message, or a third set of threshold numbers of failed random access messages. Each preamble sequence set in the plurality of preamble sequence sets, in some aspects, may be associated with one or more of a first range of powers associated with the RSRP for the reference signal from the network device, a second range of powers associated with the targeted UL power, the transmission power being the maximum transmission power, or a third range of numbers of the failed random access messages. In some aspects, the indication of the plurality of preamble sequence sets may include the common starting root associated with the plurality of preamble sequence sets, and the indication of the plurality of preamble sequence sets may further include one or more of: a set of root values associated with one of the first subset of preamble sequence sets or the second subset of preamble sequence sets, or a number of sequences in the first subset of preamble sequence sets. The first cyclic shift distance, in some aspects, may be greater than the second cyclic shift distance. In some aspects, each preamble sequence set of the plurality of preamble sequence sets may be further associated with a different range of PAPRs.

In some aspects, the indication of the plurality of preamble sequence sets indicates, for each preamble sequence set in the plurality of preamble sequence sets, one or more of: a number of sequences in the preamble sequence set, a cyclic shift distance between adjacent preamble sequences in the preamble sequence set, a threshold value associated with one of a reference signal received power (RSRP) for a reference signal from the network device or a targeted uplink (UL) power, or a threshold number of failed random access attempts. The threshold value associated with one of the RSRP or the targeted UL power, in some aspects, may be based on characteristics of a device receiving the indication. In some aspects, the characteristics may include at least one of a type of the device, a capability of the device, a state of the device, or a mode of operation of the device. For example, referring to FIG. 6, the UE 604 may receive, the one or more PRACH configurations 614, and in some aspects, additional related signaling 615.

At 804, the UE may select, based on the one or more criteria for selecting a preamble sequence set, a preamble sequence set from the plurality of preamble sequence sets and a preamble sequence within the preamble sequence set for a random access message (Msg 1). For example, 804 may be performed by application processor(s) 1206, cellular baseband processor(s) 1224, transceiver(s) 1222, antenna(s) 1280, and/or low PAPR sequence allocation component 198 of FIG. 12. Referring to FIG. 6, for example, the UE 604 may, at 622/632, select a preamble sequence set and a preamble sequence from the selected preamble sequence set.

At 806, the UE may transmit a random access message including the preamble sequence. For example, 806 may be performed by application processor(s) 1206, cellular baseband processor(s) 1224, transceiver(s) 1222, antenna(s) 1280, and/or low PAPR sequence allocation component 198 of FIG. 12. In some aspects, the preamble sequence may be a first preamble sequence from the first subset of preamble sequence sets and transmitting the random access message includes using a power amplification backoff value that is based on one of the first PAPR threshold or a PAPR associated with the preamble sequence. For example, referring to FIG. 6, the UE 604 may transmit the random access message 624/634.

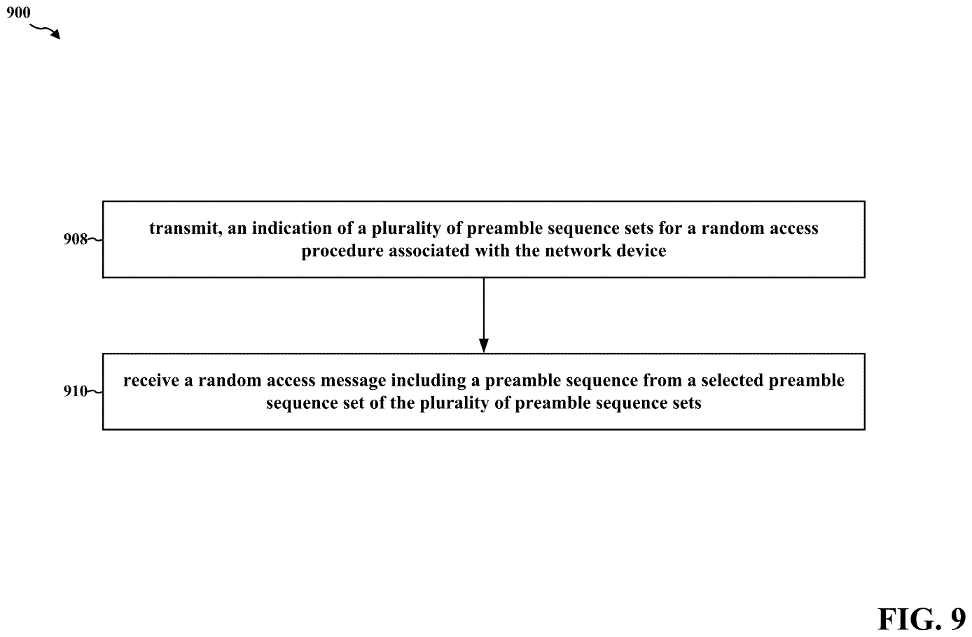

FIG. 9 is a flowchart 900 of a method of wireless communication. The method may be performed by a network device such as a base station (e.g., the base station 102, 602; the network entity 1202, 1302).

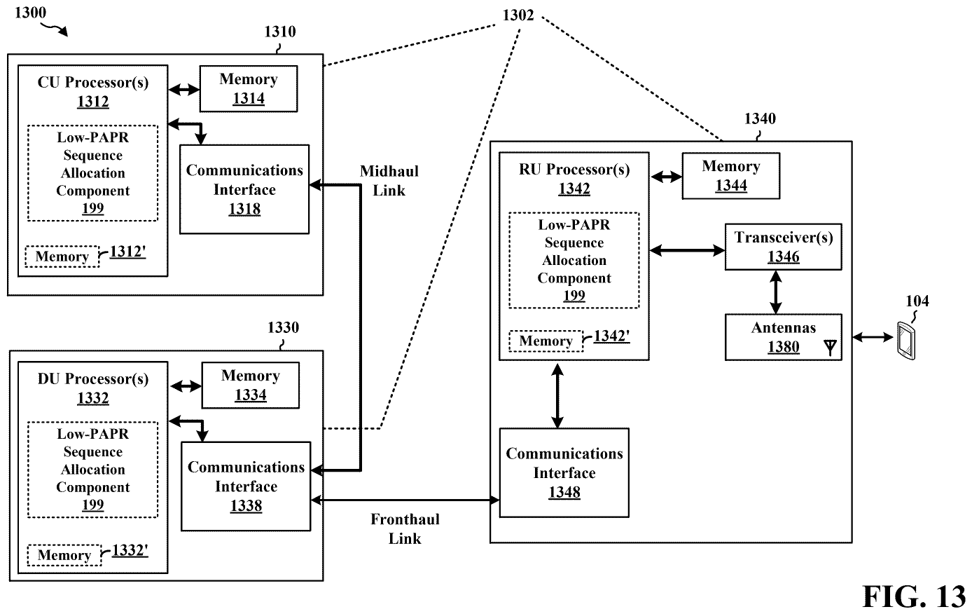

At 908, the network device may transmit an indication of a plurality of preamble sequence sets for a random access procedure associated with the network device. In some aspects, each preamble sequence set in the plurality of preamble sequence sets is associated with a different PAPR. For example, 908 may be performed by CU processor(s) 1312, DU processor(s) 1332, RU processor(s) 1342, transceiver(s) 1346, antenna(s) 1380, and/or low PAPR sequence allocation component 199 of FIG. 13. In some aspects, the plurality of preamble sequence sets may include the first subset of preamble sequence sets associated with a first PAPR that is less than a first PAPR threshold and a second subset of preamble sequence sets associated with a second PAPR that is greater than the first PAPR threshold. The indication of the plurality of preamble sequence sets, in some aspects, may include one or more of: a common starting root associated with the plurality of preamble sequence sets, a first starting root associated with the first subset of preamble sequence sets, a second starting root associated with the second subset of preamble sequence sets, a first cyclic shift distance between adjacent preamble sequences in the first subset of preamble sequence sets, a second cyclic shift distance between adjacent preamble sequences in the second subset of preamble sequence sets, or one or more indications of one or more criteria for selecting the preamble sequence set. The first cyclic shift distance, in some aspects, may be greater than the second cyclic shift distance. In some aspects, each preamble sequence set of the plurality of preamble sequence sets may be further associated with a different range of PAPRs.

In some aspects, the one or more criteria for selecting the preamble sequence set may include one or more of: a first set of power thresholds associated with a RSRP for a reference signal from the network device, a second set of power thresholds associated with a target UL power associated with the random access message, a transmission power associated with the random access message being a maximum transmission power for the random access message, or a third set of threshold numbers of failed random access messages. Each preamble sequence set in the plurality of preamble sequence sets, in some aspects, may be associated with one or more of a first range of powers associated with the RSRP for the reference signal from the network device, a second range of powers associated with the targeted UL power, the transmission power being the maximum transmission power, or a third range of numbers of the failed random access messages. In some aspects, the indication of the plurality of preamble sequence sets may include the common starting root associated with the plurality of preamble sequence sets, and the indication of the plurality of preamble sequence sets may further include one or more of: a set of root values associated with one of the first subset of preamble sequence sets or the second subset of preamble sequence sets, or a number of sequences in the first subset of preamble sequence sets.

In some aspects, the indication of the plurality of preamble sequence sets indicates, for each preamble sequence set in the plurality of preamble sequence sets, one or more of: a number of sequences in the preamble sequence set, a cyclic shift distance between adjacent preamble sequences in the preamble sequence set, a threshold value associated with one of a reference signal received power (RSRP) for a reference signal from the network device or a targeted uplink (UL) power, or a threshold number of failed random access attempts. The threshold value associated with one of the RSRP or the targeted UL power, in some aspects, may be based on characteristics of a device receiving the indication. In some aspects, the characteristics may include at least one of a type of the device, a capability of the device, a state of the device, or a mode of operation of the device. For example, referring to FIG. 6, the UE 604 may receive, the one or more PRACH configurations 614, and in some aspects, additional related signaling 615.

At 910, the network device may receive a random access message including a preamble sequence from a selected preamble sequence set of the plurality of preamble sequence sets. For example, 910 may be performed by CU processor(s) 1312, DU processor(s) 1332, RU processor(s) 1342, transceiver(s) 1346, antenna(s) 1380, and/or low PAPR sequence allocation component 199 of FIG. 13. For example, referring to FIG. 6, the base station 602 may receive random access message 624/634 based on a selection by the UE at 622/632.

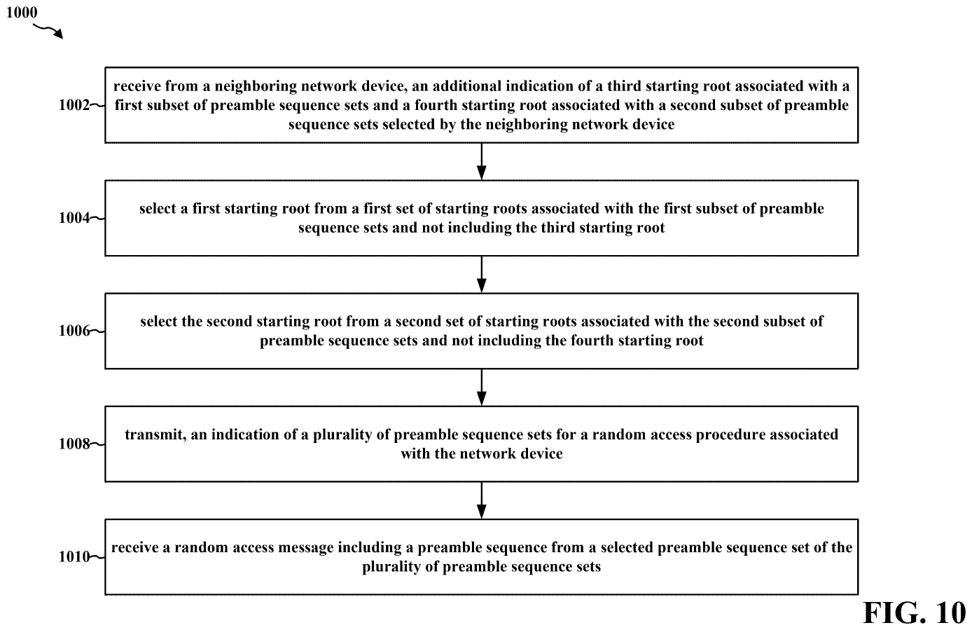

FIG. 10 is a flowchart 1000 of a method of wireless communication. The method may be performed by a network device such as a base station (e.g., the base station 102, 602; the network entity 1202, 1302). At 1007, the network device may select a plurality of preamble sequences and allocate the plurality of preamble sequences to a plurality of preamble sequence sets. For example, 1007 may be performed by CU processor(s) 1312, DU processor(s) 1332, RU processor(s) 1342, transceiver(s) 1346, antenna(s) 1380, and/or low PAPR sequence allocation component 199 of FIG. 13. In some aspects, the selection may be based on information received from one or more neighboring network devices regarding one or more starting roots (and corresponding pluralities of preamble sequences) selected by the one or more neighboring network devices. The selection, in some aspects, may include selecting a starting root and then identifying in increasing order of a first increasing cyclic shift Cv of a logical root sequence (where v is an index into a set of cyclic shift values based on a cyclic shift spacing associated with the logical root sequence), and then in increasing order of the logical root sequence index (e.g., a defined table in a standard). In some aspects, a cyclic shift spacing associated with different logical root sequences may be different, e.g., low PAPR logical root sequences may be associated with a larger cyclic shift spacing than normal/high PAPR logical root sequences. For example, referring to FIG. 6, the base station 602 may, as part of selecting one or more starting roots at 612, determine a (common) starting root (e.g., a common root index that will be used to define both a set of normal/high PAPR preamble sequences, or sequence roots, and a set of low PAPR preamble sequences, or sequence roots).

At 1008, the network device may transmit an indication of a plurality of preamble sequence sets for a random access procedure associated with the network device. In some aspects, each preamble sequence set in the plurality of preamble sequence sets is associated with a different PAPR. For example, 1008 may be performed by CU processor(s) 1312, DU processor(s) 1332, RU processor(s) 1342, transceiver(s) 1346, antenna(s) 1380, and/or low PAPR sequence allocation component 199 of FIG. 13. In some aspects, the plurality of preamble sequence sets may include the first subset of preamble sequence sets associated with a first PAPR that is less than a first PAPR threshold and a second subset of preamble sequence sets associated with a second PAPR that is greater than the first PAPR threshold. The indication of the plurality of preamble sequence sets, in some aspects, may include one or more of: a common starting root associated with the plurality of preamble sequence sets, a first cyclic shift distance between adjacent preamble sequences in the first subset of preamble sequence sets, a second cyclic shift distance between adjacent preamble sequences in the second subset of preamble sequence sets, or one or more indications of one or more criteria for selecting the preamble sequence set.

In some aspects, the one or more criteria for selecting the preamble sequence set may include one or more of: a first set of power thresholds associated with a RSRP for a reference signal from the network device, a second set of power thresholds associated with a target UL power associated with the random access message, a transmission power associated with the random access message being a maximum transmission power for the random access message, or a third set of threshold numbers of failed random access messages. Each preamble sequence set in the plurality of preamble sequence sets, in some aspects, may be associated with one or more of a first range of powers associated with the RSRP for the reference signal from the network device, a second range of powers associated with the targeted UL power, the transmission power being the maximum transmission power, or a third range of numbers of the failed random access messages. In some aspects, the indication of the plurality of preamble sequence sets may include the common starting root associated with the plurality of preamble sequence sets, and the indication of the plurality of preamble sequence sets may further include one or more of: a set of root values associated with one of the first subset of preamble sequence sets or the second subset of preamble sequence sets, or a number of sequences in the first subset of preamble sequence sets.

In some aspects, the indication of the plurality of preamble sequence sets indicates, for each preamble sequence set in the plurality of preamble sequence sets, one or more of: a number of sequences in the preamble sequence set, a cyclic shift distance between adjacent preamble sequences in the preamble sequence set, a threshold value associated with one of a reference signal received power (RSRP) for a reference signal from the network device or a targeted uplink (UL) power, or a threshold number of failed random access attempts. A first cyclic shift distance associated with the first subset of preamble sequence sets, in some aspects, may be greater than the second cyclic shift distance associated with the second subset of preamble sequence sets. In some aspects, each preamble sequence set of the plurality of preamble sequence sets may be further associated with a different range of PAPRs. The threshold value associated with one of the RSRP or the targeted UL power, in some aspects, may be based on characteristics of a device receiving the indication. In some aspects, the characteristics may include at least one of a type of the device, a capability of the device, a state of the device, or a mode of operation of the device. For example, referring to FIG. 6, the UE 604 may receive, the one or more PRACH configurations 614, and in some aspects, additional related signaling 615.

At 1010, the network device may receive a random access message including a preamble sequence from a selected preamble sequence set of the plurality of preamble sequence sets. For example, 1010 may be performed by CU processor(s) 1312, DU processor(s) 1332, RU processor(s) 1342, transceiver(s) 1346, antenna(s) 1380, and/or low PAPR sequence allocation component 199 of FIG. 13. For example, referring to FIG. 6, the base station 602 may receive random access message 624/634 based on a selection by the UE at 622/632.

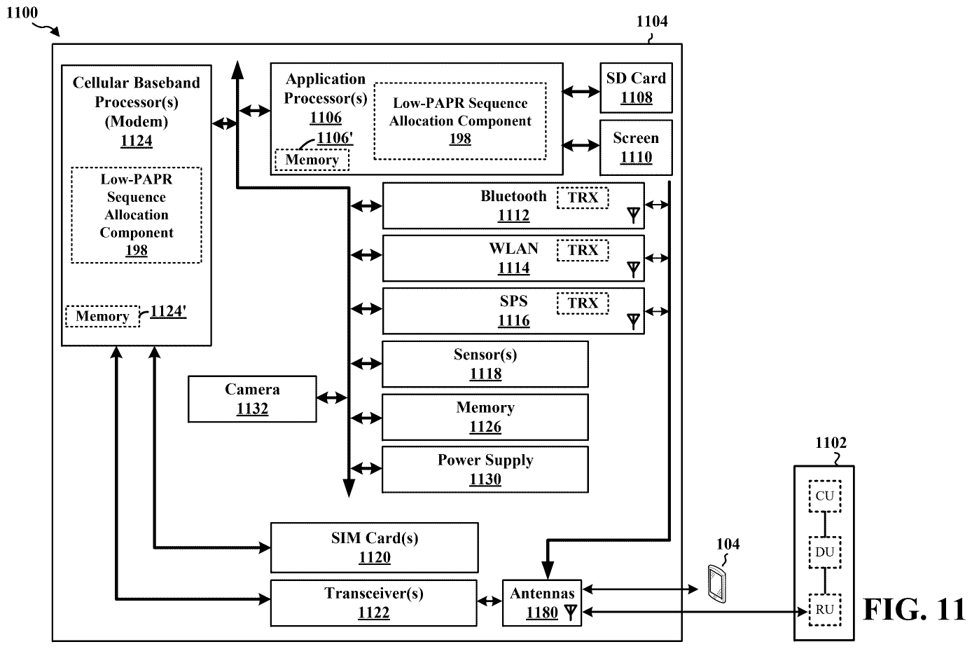

FIG. 11 is a flowchart 1100 of a method of wireless communication. The method may be performed by a network device such as a base station (e.g., the base station 102, 602; the network entity 1202, 1302). At 1102, the network device may receive, from a neighboring network device, an indication of a third starting root associated with a first subset of preamble sequence sets and a fourth starting root associated with a second subset of preamble sequence sets selected by the neighboring network device. For example, 1102 may be performed by CU processor(s) 1312, DU processor(s) 1332, RU processor(s) 1342, transceiver(s) 1346, antenna(s) 1380, and/or low PAPR sequence allocation component 199 of FIG. 13. For example, referring to FIG. 6, the base station 602 may receive from the base station(s) 606 one or more root selection(s) 610 indicating starting roots selected by the base station(s) 606.

At 1104, the network device may select the first starting root from a first set of starting roots associated with the first subset of preamble sequence sets and not including the third starting root. For example, 1104 may be performed by CU processor(s) 1312, DU processor(s) 1332, RU processor(s) 1342, transceiver(s) 1346, antenna(s) 1380, and/or low PAPR sequence allocation component 199 of FIG. 13. For example, referring to FIG. 6, the base station 602 may, as part of selecting one or more starting roots at 612, determine a first starting root for a low PAPR set of sequence roots and/or preamble sequences.

At 1106, the network device may select the second starting root from a second set of starting roots associated with the second subset of preamble sequence sets and not including the fourth starting root. For example, 1106 may be performed by CU processor(s) 1312, DU processor(s) 1332, RU processor(s) 1342, transceiver(s) 1346, antenna(s) 1380, and/or low PAPR sequence allocation component 199 of FIG. 13. For example, referring to FIG. 6, the base station 602 may, as part of selecting one or more starting roots at 612, determine a second starting root for a normal/high PAPR set of sequence roots and/or preamble sequences.

At 1108, the network device may transmit an indication of a plurality of preamble sequence sets for a random access procedure associated with the network device. In some aspects, each preamble sequence set in the plurality of preamble sequence sets is associated with a different PAPR. For example, 1108 may be performed by CU processor(s) 1312, DU processor(s) 1332, RU processor(s) 1342, transceiver(s) 1346, antenna(s) 1380, and/or low PAPR sequence allocation component 199 of FIG. 13. In some aspects, the plurality of preamble sequence sets may include the first subset of preamble sequence sets associated with a first PAPR that is less than a first PAPR threshold and a second subset of preamble sequence sets associated with a second PAPR that is greater than the first PAPR threshold. The indication of the plurality of preamble sequence sets, in some aspects, may include one or more of: a first starting root associated with the first subset of preamble sequence sets, a second starting root associated with the second subset of preamble sequence sets, a first cyclic shift distance between adjacent preamble sequences in the first subset of preamble sequence sets, a second cyclic shift distance between adjacent preamble sequences in the second subset of preamble sequence sets, or one or more indications of one or more criteria for selecting the preamble sequence set.

In some aspects, the one or more criteria for selecting the preamble sequence set may include one or more of: a first set of power thresholds associated with a RSRP for a reference signal from the network device, a second set of power thresholds associated with a target UL power associated with the random access message, a transmission power associated with the random access message being a maximum transmission power for the random access message, or a third set of threshold numbers of failed random access messages. Each preamble sequence set in the plurality of preamble sequence sets, in some aspects, may be associated with one or more of a first range of powers associated with the RSRP for the reference signal from the network device, a second range of powers associated with the targeted UL power, the transmission power being the maximum transmission power, or a third range of numbers of the failed random access messages.

In some aspects, the indication of the plurality of preamble sequence sets indicates, for each preamble sequence set in the plurality of preamble sequence sets, one or more of: a number of sequences in the preamble sequence set, a cyclic shift distance between adjacent preamble sequences in the preamble sequence set, a threshold value associated with one of a reference signal received power (RSRP) for a reference signal from the network device or a targeted uplink (UL) power, or a threshold number of failed random access attempts. A first cyclic shift distance associated with the first subset of preamble sequence sets, in some aspects, may be greater than the second cyclic shift distance associated with the second subset of preamble sequence sets. In some aspects, each preamble sequence set of the plurality of preamble sequence sets may be further associated with a different range of PAPRs. The threshold value associated with one of the RSRP or the targeted UL power, in some aspects, may be based on characteristics of a device receiving the indication. In some aspects, the characteristics may include at least one of a type of the device, a capability of the device, a state of the device, or a mode of operation of the device. For example, referring to FIG. 6, the UE 604 may receive, the one or more PRACH configurations 614, and in some aspects, additional related signaling 615.

At 1110, the network device may receive a random access message including a preamble sequence from a selected preamble sequence set of the plurality of preamble sequence sets. For example, 1110 may be performed by CU processor(s) 1312, DU processor(s) 1332, RU processor(s) 1342, transceiver(s) 1346, antenna(s) 1380, and/or low PAPR sequence allocation component 199 of FIG. 13. For example, referring to FIG. 6, the base station 602 may receive random access message 624/634 based on a selection by the UE at 622/632.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize one or more antennas 1280 for communication. The cellular baseband processor(s) 1224 communicates through the transceiver(s) 1222 via the one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The cellular baseband processor(s) 1224 and the application processor(s) 1206 are configured to perform the various functions described supra based at least in part of the information stored in the memory. That is, the cellular baseband processor(s) 1224 and the application processor(s) 1206 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., see UE 350 of FIG. 3) and include the additional modules of the apparatus 1204.

As discussed supra, the low PAPR sequence allocation component 198 may be configured to receive, from a network device, an indication of a plurality of preamble sequence sets for a random access procedure associated with the network device, where each preamble sequence set in the plurality of preamble sequence sets is associated with a different PAPR and transmit, based on one or more criteria for selecting a preamble sequence set, a random access message comprising a preamble sequence from a selected preamble sequence set of the plurality of preamble sequence sets. The low PAPR sequence allocation component 198 may be within the cellular baseband processor(s) 1224, the application processor(s) 1206, or both the cellular baseband processor(s) 1224 and the application processor(s) 1206. The low PAPR sequence allocation component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for receiving, from a network device, an indication of a plurality of preamble sequence sets for a random access procedure associated with the network device. The apparatus 1204, and in particular the cellular baseband processor(s) 1224 and/or the application processor(s) 1206, may include means for transmitting, based on one or more criteria for selecting a preamble sequence set, a random access message comprising a preamble sequence from a selected preamble sequence set of the plurality of preamble sequence sets. The apparatus 1204, and in particular the cellular baseband processor(s) 1224 and/or the application processor(s) 1206, may include means for transmitting the random access message using a power amplification backoff value that is based on one of the first PAPR threshold or a PAPR associated with the preamble sequence. The apparatus 1204, and in particular the cellular baseband processor(s) 1224 and/or the application processor(s) 1206, may include means for selecting, based on the one or more criteria for selecting a preamble sequence set, a preamble sequence set from the plurality of preamble sequence sets. The apparatus 1204, and in particular the cellular baseband processor(s) 1224 and/or the application processor(s) 1206, may include means for a preamble sequence from a selected preamble sequence set of the plurality of preamble sequence sets for the random access message. The apparatus 1204 may further include means for performing any of the aspects described in connection with the flowcharts in FIG. 7 or 8, and/or performed by the UE in the communication flow of FIG. 6. The means may be the low PAPR sequence allocation component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the low PAPR sequence allocation component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include at least one CU processor 1312. The CU processor(s) 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include at least one DU processor 1332. The DU processor(s) 1332 may include on-chip memory 1332′. In some aspects, the DU 1330 may further include additional memory modules 1334 and a communications interface 1338. The DU 1330 communicates with the RU 1340 through a fronthaul link. The RU 1340 may include at least one RU processor 1342. The RU processor(s) 1342 may include on-chip memory 1342′. In some aspects, the RU 1340 may further include additional memory modules 1344, one or more transceivers 1346, one or more antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the low PAPR sequence allocation component 199 may be configured to transmit, an indication of a plurality of preamble sequence sets for a random access procedure associated with the network device, where each preamble sequence set in the plurality of preamble sequence sets is associated with a different PAPR and receive a random access message comprising a preamble sequence from a selected preamble sequence set of the plurality of preamble sequence sets. The low PAPR sequence allocation component 199 may be within one or more processors of one or more of the CU 1310, DU 1330, and the RU 1340. The low PAPR sequence allocation component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1302 may include a variety of components configured for various functions. In one configuration, the network entity 1302 may include means for transmitting, an indication of a plurality of preamble sequence sets for a random access procedure associated with the network device. The network entity 1302, in some aspects, may include means for receiving a random access message comprising a preamble sequence from a selected preamble sequence set of the plurality of preamble sequence sets. The network entity 1302, in some aspects, may include means for receiving, from a neighboring network device, an additional indication of a third starting root associated with the first subset of preamble sequence sets and a fourth starting root associated with the second subset of preamble sequence sets selected by the neighboring network device. The network entity 1302, in some aspects, may include means for selecting the first starting root from a first set of starting roots associated with the first subset of preamble sequence sets and not including the third starting root. The network entity 1302, in some aspects, may include means for selecting the second starting root from a second set of starting roots associated with the second subset of preamble sequence sets and not including the fourth starting root. The network entity 1302 may further include means for performing any of the aspects described in connection with the flowchart in FIGS. 9-11, and/or performed by the base station in the communication flow of FIG. 6. The means may be the low PAPR sequence allocation component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

Various aspects relate generally to grouping PRACH sequences based on their PAPR characteristics so that a UE is able to transmit PRACH at a higher power if the UE is at the cell edge by switching between different PRACH sequence sets. Some aspects more specifically relate to multiple sequence set allocations based on PAPR for first random access message preambles to improve PRACH coverage. In some examples, a wireless device, such as a UE, may be configured to receive, from a network device, an indication of a plurality of preamble sequence sets for a random access procedure associated with the network device, where each preamble sequence set in the plurality of preamble sequence sets is associated with a different PAPR and transmit, based on one or more criteria for selecting a preamble sequence set, a random access message comprising a preamble sequence from a selected preamble sequence set of the plurality of preamble sequence sets. In some aspects, a base station may be configured to transmit, an indication of a plurality of preamble sequence sets for a random access procedure associated with the network device, where each preamble sequence set in the plurality of preamble sequence sets is associated with a different PAPR and receive a random access message comprising a preamble sequence from a selected preamble sequence set of the plurality of preamble sequence sets.

Particular aspects of the subject matter described in this disclosure can be implemented to realize one or more of the following potential advantages. In some examples, by providing multiple sequence set allocations for first random access message preambles based on a PAPR of the sequences, the described techniques can be used to improve PRACH coverage.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: receiving, from a network device, an indication of a plurality of preamble sequence sets for a random access procedure associated with the network device, wherein each preamble sequence set in the plurality of preamble sequence sets is associated with a different peak to average power ratio (PAPR); and transmitting, based on one or more criteria for selecting a preamble sequence set, a random access message comprising a preamble sequence from a selected preamble sequence set of the plurality of preamble sequence sets.

Aspect 2 is the method of aspect 1, wherein the plurality of preamble sequence sets comprises a first subset of preamble sequence sets associated with a first PAPR that is less than a first PAPR threshold and a second subset of preamble sequence sets associated with a second PAPR that is greater than the first PAPR threshold, wherein the preamble sequence comprises a first preamble sequence from the first subset of preamble sequence sets, and wherein transmitting the random access message further comprises transmitting the random access message using a power amplification backoff value that is based on one of the first PAPR threshold or a specific PAPR associated with the preamble sequence.

Aspect 3 is the method of aspect 2, wherein the indication of the plurality of preamble sequence sets comprises one or more of: a common starting root associated with the plurality of preamble sequence sets; a first starting root associated with the first subset of preamble sequence sets; a second starting root associated with the second subset of preamble sequence sets; a first cyclic shift distance between adjacent preamble sequences in the first subset of preamble sequence sets; a second cyclic shift distance between adjacent preamble sequences in the second subset of preamble sequence sets; or one or more indications of the one or more criteria for selecting the preamble sequence set.

Aspect 4 is the method of aspect 3, wherein the one or more criteria for selecting the preamble sequence set comprises one or more of: a first set of power thresholds associated with a reference signal received power (RSRP) for a reference signal from the network device; a second set of power thresholds associated with a targeted uplink (UL) power associated with the random access message; a transmission power associated with the random access message being a maximum transmission power for the random access message; or a third set of threshold numbers of failed random access messages.

Aspect 5 is the method of aspect 4, wherein each preamble sequence set is associated with one or more of: a first range of powers associated with the RSRP for the reference signal from the network device; a second range of powers associated with the targeted UL power; the transmission power being the maximum transmission power; or a third range of numbers of the failed random access messages.

Aspect 6 is the method of any of aspects 3 to 5, wherein the indication of the plurality of preamble sequence sets comprises the common starting root associated with the plurality of preamble sequence sets, and wherein the indication of the plurality of preamble sequence sets further comprises one or more of: a set of root values associated with one of the first subset of preamble sequence sets or the second subset of preamble sequence sets; or a number of sequences in the first subset of preamble sequence sets.

Aspect 7 is the method of any of aspects 3 to 6, wherein the first cyclic shift distance is greater than the second cyclic shift distance.

Aspect 8 is the method of any of aspects 1 to 7, wherein each preamble sequence set is further associated with a different range of PAPRs.

Aspect 9 is the method of any of aspects 1 to 8, wherein the indication of the plurality of preamble sequence sets indicates, for each preamble sequence set in the plurality of preamble sequence sets, one or more of: a number of sequences in the preamble sequence set; a cyclic shift distance between adjacent preamble sequences in the preamble sequence set; a threshold value associated with one of a reference signal received power (RSRP) for a reference signal from the network device or a targeted uplink (UL) power; or a threshold number of failed random access attempts.

Aspect 10 is the method of aspect 9, wherein the threshold value associated with one of the RSRP or the targeted UL power is based on characteristics of a device receiving the indication, wherein the characteristics comprise at least one of a type of the device, a capability of the device, a state of the device, or a mode of operation of the device.

Aspect 11 is a method of wireless communication at a network device, comprising: transmitting, an indication of a plurality of preamble sequence sets for a random access procedure associated with the network device, wherein each preamble sequence set in the plurality of preamble sequence sets is associated with a different peak to average power ratio (PAPR); and receiving a random access message comprising a preamble sequence from a selected preamble sequence set of the plurality of preamble sequence sets.

Aspect 12 is the method of aspect 11, wherein the plurality of preamble sequence sets comprises a first subset of preamble sequence sets associated with a first PAPR that is less than a first PAPR threshold and a second subset of preamble sequence sets associated with a second PAPR that is greater than the first PAPR threshold, wherein the preamble sequence comprises a first preamble sequence from the first subset of preamble sequence sets, and wherein the indication of the plurality of preamble sequence sets comprises one or more of: a common starting root associated with the plurality of preamble sequence sets; a first starting root associated with the first subset of preamble sequence sets; a second starting root associated with the second subset of preamble sequence sets; a first cyclic shift distance between adjacent preamble sequences in the first subset of preamble sequence sets; a second cyclic shift distance between adjacent preamble sequences in the second subset of preamble sequence sets; or one or more indications of the one or more criteria for selecting the selected preamble sequence set.

Aspect 13 is the method of aspect 12, wherein the one or more criteria for selecting the selected preamble sequence set comprises one or more of: a first set of power thresholds associated with a reference signal received power (RSRP) for a reference signal from the network device; a second set of power thresholds associated with a target uplink (UL) power associated with the random access message; a transmission power associated with the random access message being a maximum transmission power for the random access message; or a third set of threshold numbers of failed random access messages.

Aspect 14 is the method of aspect 13, wherein each preamble sequence set is associated with one or more of: a first range of powers associated with the RSRP for the reference signal from the network device; a second range of powers associated with the targeted UL power; the transmission power being the maximum transmission power; or a third range of numbers of the failed random access messages.

Aspect 15 is the method of any of aspects 12 to 14, wherein the indication of the plurality of preamble sequence sets comprises the common starting root associated with the plurality of preamble sequence sets, and wherein the indication of the plurality of preamble sequence sets further comprises one or more of: a set of root values associated with one of the first subset of preamble sequence sets or the second subset of preamble sequence sets; or a number of sequences in the first subset of preamble sequence sets.

Aspect 16 is the method of any of aspects 12 to 15, wherein the first cyclic shift distance is greater than the second cyclic shift distance.

Aspect 17 is the method of any of aspects 12 to 14 and 16, wherein the indication of the plurality of preamble sequence sets comprises the first starting root associated with the first subset of preamble sequence sets and the second starting root associated with the second subset of preamble sequence sets, the method further comprising: receiving, from a neighboring network device, an additional indication of a third starting root associated with the first subset of preamble sequence sets and a fourth starting root associated with the second subset of preamble sequence sets selected by the neighboring network device; selecting the first starting root from a first set of starting roots associated with the first subset of preamble sequence sets and not including the third starting root; and selecting the second starting root from a second set of starting roots associated with the second subset of preamble sequence sets and not including the fourth starting root.

Aspect 18 is the method of any of aspects 11 to 17, wherein each preamble sequence set is further associated with a different range of PAPRs.

Aspect 19 is the method of any of aspects 11 to 18, wherein the indication of the plurality of preamble sequence sets indicates, for each preamble sequence set in the plurality of preamble sequence sets, one or more of: a number of sequences in the preamble sequence set; a cyclic shift distance between adjacent preamble sequences in the preamble sequence set; a threshold value associated with one of a reference signal received power (RSRP) for a reference signal from the network device or a targeted uplink (UL) power; or a threshold number of failed random access attempts.

Aspect 20 is the method of aspect 19, wherein the threshold value associated with one of the RSRP or the targeted UL power is based on characteristics of a device receiving the indication, wherein the characteristics comprise at least one of a type of the device, a capability of the device, a state of the device, or a mode of operation of the device.

Aspect 21 is an apparatus for wireless communication at a UE, comprising: at least one memory; and at least one processor coupled to the at least one memory, the at least one processor is configured to perform the method of any of aspects 1 to 10.

Aspect 22 is an apparatus for wireless communication at a UE, comprising means for performing each step in the method of any of aspects 1 to 10.

Aspect 23 is the apparatus of any of aspects 21 to 22, further comprising a transceiver configured to receive or to transmit in association with the method of any of aspects 1 to 10.

Aspect 24 is a computer-readable medium storing computer executable code at a UE, the code when executed by at least one processor causes the at least one processor to perform the method of any of aspects 1 to 10.

Aspect 25 is an apparatus for wireless communication at a network device, comprising: at least one memory; and at least one processor coupled to the at least one memory, the at least one processor is configured to perform the method of any of aspects 11 to 20.

Aspect 26 is an apparatus for wireless communication at a network device, comprising means for performing each step in the method of any of aspects 11 to 20.

Aspect 27 is the apparatus of any of aspects 25 to 26, further comprising a transceiver configured to receive or to transmit in association with the method of any of aspects 11 to 20.

Aspect 28 is a computer-readable medium storing computer executable code at a network device, the code when executed by at least one processor causes the at least one processor to perform the method of any of aspects 11 to 20.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
receive, from a network device, an indication of a plurality of preamble sequence sets for a random access procedure associated with the network device, wherein each preamble sequence set in the plurality of preamble sequence sets is associated with a different peak to average power ratio (PAPR); and
transmit, based on one or more criteria for selecting a preamble sequence set, a random access message comprising a preamble sequence from a selected preamble sequence set of the plurality of preamble sequence sets.

2. The apparatus of claim 1, wherein the plurality of preamble sequence sets comprises a first subset of preamble sequence sets associated with a first PAPR that is less than a first PAPR threshold and a second subset of preamble sequence sets associated with a second PAPR that is greater than the first PAPR threshold, wherein the preamble sequence comprises a first preamble sequence from the first subset of preamble sequence sets, and wherein, to transmit the random access message, the at least one processor is configured to transmit the random access message using a power amplification backoff value that is based on one of the first PAPR threshold or a specific PAPR associated with the preamble sequence.

3. The apparatus of claim 2, wherein the indication of the plurality of preamble sequence sets comprises one or more of:
a common starting root associated with the plurality of preamble sequence sets;
a first starting root associated with the first subset of preamble sequence sets;
a second starting root associated with the second subset of preamble sequence sets;
a first cyclic shift distance between adjacent preamble sequences in the first subset of preamble sequence sets;
a second cyclic shift distance between adjacent preamble sequences in the second subset of preamble sequence sets; or
one or more indications of the one or more criteria for selecting the preamble sequence set.

4. The apparatus of claim 3, wherein the one or more criteria for selecting the preamble sequence set comprises one or more of:
a first set of power thresholds associated with a reference signal received power (RSRP) for a reference signal from the network device;
a second set of power thresholds associated with a targeted uplink (UL) power associated with the random access message;
a transmission power associated with the random access message being a maximum transmission power for the random access message; or
a third set of threshold numbers of failed random access messages.

5. The apparatus of claim 4, wherein each preamble sequence set is associated with one or more of:
a first range of powers associated with the RSRP for the reference signal from the network device;
a second range of powers associated with the targeted UL power;
the transmission power being the maximum transmission power; or
a third range of numbers of the failed random access messages.

6. The apparatus of claim 3, wherein the indication of the plurality of preamble sequence sets comprises the common starting root associated with the plurality of preamble sequence sets, and wherein the indication of the plurality of preamble sequence sets further comprises one or more of:
a set of root values associated with one of the first subset of preamble sequence sets or the second subset of preamble sequence sets; or
a number of sequences in the first subset of preamble sequence sets.

7. The apparatus of claim 3, wherein the first cyclic shift distance is greater than the second cyclic shift distance.

8. The apparatus of claim 1, wherein each preamble sequence set is further associated with a different range of PAPRs.

9. The apparatus of claim 1, wherein the indication of the plurality of preamble sequence sets indicates, for each preamble sequence set in the plurality of preamble sequence sets, one or more of:
a number of sequences in the preamble sequence set;
a cyclic shift distance between adjacent preamble sequences in the preamble sequence set;
a threshold value associated with one of a reference signal received power (RSRP) for a reference signal from the network device or a targeted uplink (UL) power; or
a threshold number of failed random access attempts.

10. The apparatus of claim 9, wherein the threshold value associated with one of the RSRP or the targeted UL power is based on characteristics of a device receiving the indication, wherein the characteristics comprise at least one of a type of the device, a capability of the device, a state of the device, or a mode of operation of the device.

11. An apparatus for wireless communication at a network device, comprising:
at least one memory; and
at least one processor coupled to the at least one memory and, based at least in part on information stored in the at least one memory, the at least one processor is configured to:
transmit, an indication of a plurality of preamble sequence sets for a random access procedure associated with the network device, wherein each preamble sequence set in the plurality of preamble sequence sets is associated with a different peak to average power ratio (PAPR); and
receive a random access message comprising a preamble sequence from a selected preamble sequence set of the plurality of preamble sequence sets.

12. The apparatus of claim 11, wherein the plurality of preamble sequence sets comprises a first subset of preamble sequence sets associated with a first PAPR that is less than a first PAPR threshold and a second subset of preamble sequence sets associated with a second PAPR that is greater than the first PAPR threshold, wherein the preamble sequence comprises a first preamble sequence from the first subset of preamble sequence sets, and wherein the indication of the plurality of preamble sequence sets comprises one or more of:
a common starting root associated with the plurality of preamble sequence sets;
a first starting root associated with the first subset of preamble sequence sets;
a second starting root associated with the second subset of preamble sequence sets;
a first cyclic shift distance between adjacent preamble sequences in the first subset of preamble sequence sets;
a second cyclic shift distance between adjacent preamble sequences in the second subset of preamble sequence sets; or
one or more indications of one or more criteria for selecting the selected preamble sequence set.

13. The apparatus of claim 12, wherein the one or more criteria for selecting the selected preamble sequence set comprises one or more of:
a first set of power thresholds associated with a reference signal received power (RSRP) for a reference signal from the network device;
a second set of power thresholds associated with a target uplink (UL) power associated with the random access message;
a transmission power associated with the random access message being a maximum transmission power for the random access message; or
a third set of threshold numbers of failed random access messages.

14. The apparatus of claim 13, wherein each preamble sequence set is associated with one or more of:
a first range of powers associated with the RSRP for the reference signal from the network device;
a second range of powers associated with the targeted UL power;
the transmission power being the maximum transmission power; or
a third range of numbers of the failed random access messages.

15. The apparatus of claim 12, wherein the indication of the plurality of preamble sequence sets comprises the common starting root associated with the plurality of preamble sequence sets, and wherein the indication of the plurality of preamble sequence sets further comprises one or more of:
a set of root values associated with one of the first subset of preamble sequence sets or the second subset of preamble sequence sets; or
a number of sequences in the first subset of preamble sequence sets.

16. The apparatus of claim 12, wherein the first cyclic shift distance is greater than the second cyclic shift distance.

17. The apparatus of claim 12, wherein the indication of the plurality of preamble sequence sets comprises the first starting root associated with the first subset of preamble sequence sets and the second starting root associated with the second subset of preamble sequence sets, wherein the at least one processor is configured to:
receive, from a neighboring network device, an additional indication of a third starting root associated with the first subset of preamble sequence sets and a fourth starting root associated with the second subset of preamble sequence sets selected by the neighboring network device;
select the first starting root from a first set of starting roots associated with the first subset of preamble sequence sets and not including the third starting root; and
select the second starting root from a second set of starting roots associated with the second subset of preamble sequence sets and not including the fourth starting root.

18. The apparatus of claim 11, wherein each preamble sequence set is further associated with a different range of PAPRs.

19. The apparatus of claim 11, wherein the indication of the plurality of preamble sequence sets indicates, for each preamble sequence set in the plurality of preamble sequence sets, one or more of:
a number of sequences in the preamble sequence set;
a cyclic shift distance between adjacent preamble sequences in the preamble sequence set;
a threshold value associated with one of a reference signal received power (RSRP) for a reference signal from the network device or a targeted uplink (UL) power; or
a threshold number of failed random access attempts.

20. The apparatus of claim 19, wherein the threshold value associated with one of the RSRP or the targeted UL power is based on characteristics of a device receiving the indication, wherein the characteristics comprise at least one of a type of the device, a capability of the device, a state of the device, or a mode of operation of the device.

21. A method of wireless communication at a user equipment (UE), comprising:
receiving, from a network device, an indication of a plurality of preamble sequence sets for a random access procedure associated with the network device, wherein each preamble sequence set in the plurality of preamble sequence sets is associated with a different peak to average power ratio (PAPR); and
transmitting, based on one or more criteria for selecting a preamble sequence set, a random access message comprising a preamble sequence from a selected preamble sequence set of the plurality of preamble sequence sets.

22. The method of claim 21, wherein the plurality of preamble sequence sets comprises a first subset of preamble sequence sets associated with a first PAPR that is less than a first PAPR threshold and a second subset of preamble sequence sets associated with a second PAPR that is greater than the first PAPR threshold, wherein the preamble sequence comprises a first preamble sequence from the first subset of preamble sequence sets, and wherein transmitting the random access message further comprises transmitting the random access message using a power amplification backoff value that is based on one of the first PAPR threshold or a specific PAPR associated with the preamble sequence.

23. The method of claim 22, wherein the indication of the plurality of preamble sequence sets comprises one or more of:
a common starting root associated with the plurality of preamble sequence sets;
a first starting root associated with the first subset of preamble sequence sets;
a second starting root associated with the second subset of preamble sequence sets;
a first cyclic shift distance between adjacent preamble sequences in the first subset of preamble sequence sets;
a second cyclic shift distance between adjacent preamble sequences in the second subset of preamble sequence sets; or
one or more indications of the one or more criteria for selecting the preamble sequence set.

24. The method of claim 21, wherein each preamble sequence set is further associated with a different range of PAPRs.

25. The method of claim 21, wherein the indication of the plurality of preamble sequence sets indicates, for each preamble sequence set in the plurality of preamble sequence sets, one or more of:
a number of sequences in the preamble sequence set;
a cyclic shift distance between adjacent preamble sequences in the preamble sequence set;
a threshold value associated with one of a reference signal received power (RSRP) for a reference signal from the network device or a targeted uplink (UL) power; or
a threshold number of failed random access attempts.

26. A method of wireless communication at a network device, comprising:
transmitting, an indication of a plurality of preamble sequence sets for a random access procedure associated with the network device, wherein each preamble sequence set in the plurality of preamble sequence sets is associated with a different peak to average power ratio (PAPR); and
receiving a random access message comprising a preamble sequence from a selected preamble sequence set of the plurality of preamble sequence sets.

27. The method of claim 26, wherein the plurality of preamble sequence sets comprises a first subset of preamble sequence sets associated with a first PAPR that is less than a first PAPR threshold and a second subset of preamble sequence sets associated with a second PAPR that is greater than the first PAPR threshold, wherein the preamble sequence comprises a first preamble sequence from the first subset of preamble sequence sets, and wherein the indication of the plurality of preamble sequence sets comprises one or more of:
a common starting root associated with the plurality of preamble sequence sets;
a first starting root associated with the first subset of preamble sequence sets;
a second starting root associated with the second subset of preamble sequence sets;
a first cyclic shift distance between adjacent preamble sequences in the first subset of preamble sequence sets;
a second cyclic shift distance between adjacent preamble sequences in the second subset of preamble sequence sets; or
one or more indications of one or more criteria for selecting the selected preamble sequence set.

28. The method of claim 27, wherein the one or more criteria for selecting the selected preamble sequence set comprises one or more of:
a first set of power thresholds associated with a reference signal received power (RSRP) for a reference signal from the network device;
a second set of power thresholds associated with a target uplink (UL) power associated with the random access message;
a transmission power associated with the random access message being a maximum transmission power for the random access message; or
a third set of threshold numbers of failed random access messages.

29. The method of claim 27, wherein the indication of the plurality of preamble sequence sets comprises the common starting root associated with the plurality of preamble sequence sets, and wherein the indication of the plurality of preamble sequence sets further comprises one or more of:
a set of root values associated with one of the first subset of preamble sequence sets or the second subset of preamble sequence sets; or
a number of sequences in the first subset of preamble sequence sets.

30. The method of claim 27, wherein the indication of the plurality of preamble sequence sets comprises the first starting root associated with the first subset of preamble sequence sets and the second starting root associated with the second subset of preamble sequence sets, the method further comprising:
receiving, from a neighboring network device, an additional indication of a third starting root associated with the first subset of preamble sequence sets and a fourth starting root associated with the second subset of preamble sequence sets selected by the neighboring network device;
selecting the first starting root from a first set of starting roots associated with the first subset of preamble sequence sets and not including the third starting root; and
selecting the second starting root from a second set of starting roots associated with the second subset of preamble sequence sets and not including the fourth starting root.
